(19) United States
(12) Patent Application Publication
(10) Pub. No.: US 2019/0382133 A1
(43) Pub. Date: Dec. 19, 2019

(54) UNMANNED AERIAL VEHICLE

(71) Applicant: SZ DJI TECHNOLOGY CO., LTD., Shenzhen (CN)

(72) Inventor: Yongsheng ZHANG, Shenzhen (CN)

(21) Appl. No.: 16/548,563

(22) Filed: Aug. 22, 2019

Related U.S. Application Data
(63) Continuation of application No. PCT/CN2017/074767, filed on Feb. 24, 2017.

(51) Int. Cl. B64D 47/08; B64C 39/02; G05D 1/00

(52) U.S. Cl. CPC B64D 47/08; B64C 2201/127; G05D 1/0011; B64C 39/024

(57) ABSTRACT

The present disclosure provides an Unmanned Aerial Vehicle (UAV). The vehicle includes a main body; a supporting frame that is connected to the main body; two mounting brackets that are spaced apart; a plurality of shock absorbing structures that connect the supporting frame and the mounting brackets; and two gimbals configured to carry a plurality of payloads. The two gimbals are respectively connected to the two mounting brackets, and the shock absorbing structures absorb shocks on the gimbals.

### CROSS-REFERENCE TO RELATED APPLICATION

This application is a continuation application of International Application No. PCT/CN2017/074767, filed on Feb. 24, 2017, the entire content of which is incorporated herein by reference.

### TECHNICAL FIELD

The present disclosure relates to the field of Unmanned Aerial Vehicle (UAV) technology and, more particularly, to a gimbal assembly and a frame.

### BACKGROUND

UAVs are unmanned aerial vehicles that may be operated using radio remote control and onboard program control devices. Due to its compactness, lower manufacturing cost, and ease of operation, UAVs have been widely adopted in fields such as aerial photography, survey, inspection, rescue, etc.

An UAV typically includes a frame to carry various components of the UAV such as an inertial navigation module, a camera, etc. Further, the camera may be mounted on the gimbal at the bottom of the frame. Often, a frame typically carries one gimbal. As a result, the unmanned aerial vehicle can only record image information using one camera.

### SUMMARY

In view of the current designs, the present disclosure provides a gimbal and a frame to enhance the images recorded by the UAV.

On aspect of the present disclosure provides a UAV. The UAV includes a main body; a supporting frame that is connected to the main body; two mounting brackets that are spaced apart; a plurality of shock absorbing structures that connect the supporting frame and the mounting brackets; and two gimbals configured to carry a plurality of payloads. The two gimbals are respectively connected to the two mounting brackets, and the shock absorbing structures absorb shocks on the gimbals.

The gimbal and the supporting frame provided in the present disclosure allow two or more mounting brackets to be mounted on the frame of the gimbal, so the frame will be able to carry two or more gimbals and two or more image information streams may be captured simultaneously, thereby serving multiple purposes of the UAV equipped with the gimbals and the supporting frame described in the present disclosure.

### BRIEF DESCRIPTION OF THE DRAWINGS

FIG. 1 is a schematic structural diagram of a gimbal assembly and a payload according to a First Embodiment of the present disclosure;

FIG. 2 is a schematic structural diagram of the gimbal and the payload according to a Third Embodiment of the present disclosure;

FIG. 3 is a partially enlarged view of FIG. 2;

FIG. 4 is a schematic structural view of a shock absorbing ball according to a Seventh Embodiment of the present disclosure;

FIG. 5 is a first schematic structural diagram of the gimbal and the payload according to an Eleventh Embodiment of the present disclosure;

FIG. 6 is a second schematic structural diagram of the gimbal and the payload according to the Eleventh Embodiment of the present disclosure;

FIG. 7 is a schematic structural view of a frame according to a Seventeenth Embodiment of the present disclosure; and

FIG. 8 is a partially enlarged view of FIG. 7.

It should be noted that the reference numerals shown in the drawings are described as follows:

100: gimbal assembly;

110: supporting frame;

110a: connection hole;

110b: wiring hole;

111: mounting member;

120: shock absorbing structure;

121: shock absorbing ball;

121a: ball body;

121b: first end;

121c: second end;

130: mounting bracket;

131: first mounting bracket;

132: second mounting bracket;

133: quick release;

140: gimbal;

141: first gimbal;

141a: first snap;

142: second gimbal;

200: payload;

210: first payload;

220: second payload;

300: main body;

310: battery compartment;

400: landing gear;

500: connection bracket;

510: obstacle avoidance detection member;

520: FPV camera.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. Further, the embodiments and the features of the present disclosure may be combined together provided that no conflict occurs among the embodiments.

For illustrative purpose only, the terms “above”, “below”, “in front”, “behind”, etc. are used to describe the relative positional relationship of the respective components described in the drawings, and are not intended to limit the scope of the present disclosure. Therefore, without making substantial changes in the technical solution, the relative relationship of the components may be changed or modified, and should be also considered as within the scope of the present disclosure.

It should be noted that, in the description of the present disclosure, the terms “first” and “second” are merely used for conveniently describing different components, and should not be construed as indicating or implying a sequential relationship or relative importance, or implicitly indicating the quantity of indicated technical features. Therefore, the quantity of features defined with “first” and “second” may be explicitly or implicitly at least one.

### First Embodiment

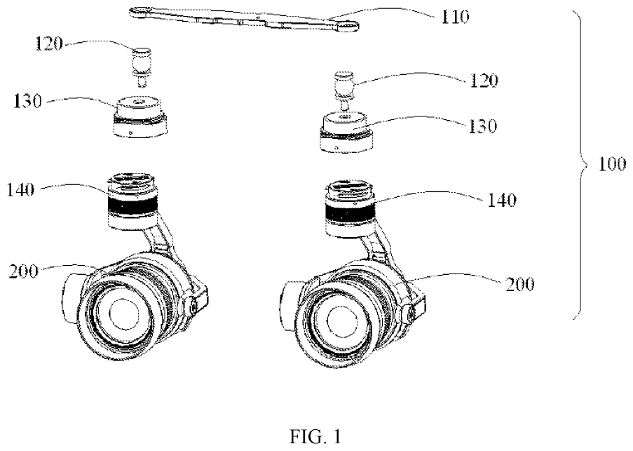

FIG. 1 is a schematic structural diagram of a Gimbal and a payload according to a first embodiment of the present disclosure. Referring to FIG. 1, the gimbal assembly of the present disclosure includes a supporting frame 110; two or more mounting brackets 130 that are spaced apart and disposed opposite to the supporting frame 110; a plurality of shock absorbing structures 120 to connect the supporting frame 110 and the mounting brackets 130; and two or more gimbals to carry a plurality of payloads 200. Further, the two or more gimbals 140 may be fixedly connected to the two or more mounting brackets 130 respectively, and the shocks on the gimbals 140 may be absorbed by the shock absorbing structures, such that the supporting frame 110 may carry two or more gimbals 140.

More specifically, the Gimbal assembly 100 may be mounted on a carrier, for example, it may be mounted on a frame of an UAV or other devices that may be used to capture image information. Hence, the supporting frame 110 in the present embodiment may be the carrier itself. Further, for the ease of repairing and replacing of the gimbal assembly 100, the frame 100 of the present embodiment may be a separate component independent of the carrier. Furthermore, in the present embodiment, the supporting frame 110 is used to connect the carrier that carries the gimbal assembly 100.

For example, the supporting frame 110 may have a symmetrical structure. Further, if the supporting frame 110 includes an even number of mounting brackets 130, the mounting brackets 130 may be symmetrically disposed along the symmetric center of the supporting frame 110. Furthermore, if the supporting frame 110 includes an odd number of mounting brackets 130, an even number of mounting brackets 130 may be symmetrically disposed along the symmetrical center of the supporting frame 110, and the remaining mounting brackets 130 may be disposed on the centerline of the supporting frame 110 so the center of gravity of the Gimbal assembly 100 may be as close to the centerline of the gimbal assembly 100 as possible. Of course, the supporting frame 110 is not limited to a symmetrical structure, and it may be an asymmetrical structure as long as it serves the purpose of connecting the carrier and the mounting brackets 130. The specific structure of the supporting frame 110 and the mounting brackets 130 are not limited in the present embodiment, and those skilled in the art may modify the structure based on the actual needs as long as it serves the purpose of connecting the carrier and the gimbals 140.

Each mounting bracket 130 may be evenly disposed on the supporting frame 110 so the force on the supporting frame 110 may be evenly distributed, which may help to extend the service life of the supporting frame 110. Further, by spacing the mounting brackets 130 apart, the interference between the gimbals 140 may be effectively avoided to ensure each gimbals 140 can operate effectively. The specific distance between the mounting brackets 130 is not limited in the present embodiment, and those skilled in the art may modify the distance based on the actual needs as long as there is no interference between the gimbals.

The payload 200 may be a collecting unit for collecting image information, such as a camera, or it may be a spraying device, a transmitting device, etc. The present embodiment uses the collecting unit as the payload 200 as an example in the following description.

In order to ensure the quality of the image information the collecting unit collects, the stability of the collecting unit is very important, therefore, the shock absorbing structures 120 may be disposed between the gimbals 140 and the carrier to reduce the vibration transmitted from the carrier to the payloads 200 mounted on the gimbals 140. In some embodiments, the shock absorbing structures 120 may be disposed between the supporting frame 110 and the mounting brackets 130, so that when the payloads 200 mounted on the gimbals 140 change, the shock absorbing structures 120 between the corresponding mounting brackets 130 and the supporting frame 110 may be conveniently adjusted based on the weight of the payloads 200 to ensure the shock absorbing effect of the shock absorbing structures 120, thereby enhancing the stability of the gimbals 140 and the payloads 200 it carries.

The specific structure of the shock absorbing structures 120 is not limited in the present embodiment, and those skilled in the art may make adjustments based on the actual needs as long as it serves the purpose of effectively absorbing shock. In addition, the specific structure of the gimbals 140 is not limited in the present embodiment, and those skilled in the art may make adjustments based on the actual needs as long as it serves the purpose of mounting the payloads 200 and fixedly connecting to the mounting brackets 130. For example, the structure of the gimbals 140 may be identical or similar to the structure of a conventional gimbal.

The gimbal assembly 100 of the present disclosure includes two or more mounting brackets 130 connected to the supporting frame 110 so the supporting frame 110 may carry two or more gimbals 140, and the payloads 200 carried by the two or more gimbals may simultaneously capture two or more image information, thereby satisfying the various purposes of the carrier that carries the gimbal assembly 100.

### Second Embodiment

Further to the First Embodiment, the supporting frame 110 may further include an integrally formed plate-shaped body, so the vibrations on each gimbal 140 mounted on the supporting frame 110 will be similar, and it may be more convenient for the subsequent processing of the image information captured by the payload 200 mounted on each gimbal.

More specifically, the plate-shaped body may include a plurality of mounting areas, where each mounting area may be used to mount a corresponding mounting bracket 130. The present embodiment uses the structure of a supporting frame 110 with two gimbals 140 mounted on it as an example to describe the structure of the plate-shaped body. The plate-shaped body may be a complete plate-like structure, for example, the plate-shaped body may be rectangular, elliptical or the like. Further, two mounting brackets 130 may be symmetrically disposed on both sides of the plate-shaped body along the longitudinal direction of the plate-shaped body. Furthermore, to reduce the weight of the Gimbal assembly 100, the plate-shaped body may include a plurality of weight-reducing holes or weight-reducing slots that may be symmetrically disposed so the force on the plate-shaped body may be evenly distributed.

Of course, the specific structure of the supporting frame 110 and the mounting position of each mounting bracket are not limited, and those skilled in the art may adjust the structure based on the number of mounting brackets 130. For example, in the case of three mounting brackets 130, the shape of the plate-shaped body may be rectangular, and the three mounting brackets 130 may be linearly arranged on the plate-shaped body, or, the shape of the plate-shaped body may be triangular, and the three mounting brackets 130 may be respectively disposed at the three vertices. Further, in the case of four mounting brackets 130, the shape of the plate-shaped body may be a symmetrical quadrilateral, and the four mounting brackets 130 may be respectively disposed at the four vertices, or, the shape of the plate-shaped body may be triangular, where three mounting brackets may be disposed at the three vertices, and the other mounting bracket 130 may be disposed at the center of the triangle.

It should be noted that the supporting frame 110 needs to have a certain carrying capacity to satisfy the carrying capacity of the plurality of gimbals 140. In addition, the structure of the plate-shaped body may be reinforced based on the actual needs. For example, a reinforcing rib or a reinforcing plate may be added on the plate-shaped body to improve the strength of the supporting frame 110.

### Third Embodiment

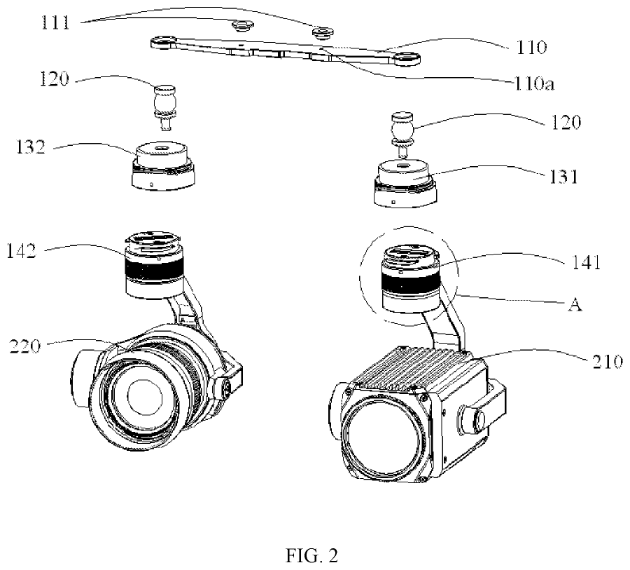

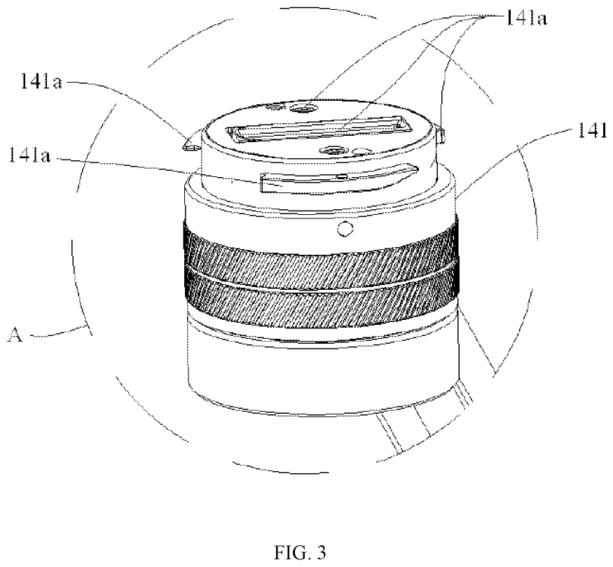

FIG. 2 is a schematic structural diagram of the gimbal assembly and the payload according to the third embodiment of the present disclosure. Further, FIG. 3 is a partially enlarged view of FIG. 2. Referring to FIG. 2 and FIG. 3, further to the previous embodiments, the gimbals 140 may be quickly disconnected from the mounting brackets 130, such that the gimbals 140 may be mounted on the mounting brackets 130 by hand, so the gimbals 140 may be conveniently replaced with different payloads 200.

More specifically, the gimbals 140 may include a first gimbal 141 and a second gimbal 142; and the mounting brackets 130 may include a first mounting bracket 131 and a second mounting bracket 132. The first gimbal 141 may include a first snap 141a, and the first mounting bracket 131 may include a first matching part for matching the first snap 141a to mount the first gimbal 141 on the first mounting bracket 131. The second gimbal 142 may include a second snap, and the second mounting bracket 132 may include a second matching part for matching the second snap to mount the second gimbal 142 on the second mounting bracket 132. Further, the connection between each gimbal 140 carried by the supporting frame 110 and the corresponding mounting brackets 130 may be the same or different.

In some embodiments, the first gimbal 141 and the second gimbal 142 may be different gimbals, and the first snap 141a and the second snap may be different as well, therefore, when replacing the gimbals 140 carried by the supporting frame 110, the gimbals 140 and the mounting brackets 130 may need to be replace together. For example, when replacing the first gimbal 141 carried by the supporting frame 110 with the second gimbal 142, the first mounting bracket 131 on the supporting frame 110 may need to be replaced with the second mounting bracket 132. Further, the first gimbal 141 may be used to carry a first payload 210, the second gimbal may be used to carry a second payload 220, and the first and second payloads may be different.

In some embodiments, the first snap 141a and the second snap may be the same, and the first matching part and the second matching part may be the same as well, such that the first gimbal 141 and the second gimbal 142 may be interchangeable, thereby improving the installation efficiency of the gimbals 140.

### Fourth Embodiment

Further to the Third Embodiment, the present embodiment explains the connection between the gimbals 140 and the mounting brackets 130 using a screw connection as an example.

More specifically, using the first gimbal 141 and the first mounting bracket 131 as an example, the first snap 141a of the first gimbal may be a threaded structure, correspondingly, the first matching part of the first mounting bracket 131 may be a threaded hole. The screw connection allows the Gimbal assembly 100 to be more compact, thereby reducing the size of Gimbal assembly 100.

Of course, the connection between the first gimbal 141 and the first mounting bracket is not limited to the screw connection, and those skilled in the art may modify the connection based on the actual needs as long as the connection servers the purpose of quickly disconnecting the gimbals 140 and the mounting brackets 130. For example, the first snap 141a on the first gimbal 141 may be a threaded hole, and the first matching part on the first mounting bracket 131 may be a stud. In another example, the first snap 141a on the first gimbal 141 may be a stud, and the first matching part on the first mounting bracket 131 may be a threaded hole. The connection between the second snap on the second gimbal 142 and the second matching part of the second mounting bracket 132 may be the same as the first snap 141a on the first gimbal 141 and the first matching part on the first mounting bracket 131.

### Fifth Embodiment

Further to the Third and Fourth Embodiments, the present embodiment explains the connection between the gimbal 140s and the mounting brackets 130 using a snap connection as an example. In this embodiment, the first snap 141a may be rotatably or slidably connected to the first matching part, and the second snap may be rotatably or slidably connected to the second matching part.

More specifically, the first snap 141a and the second snap may include one of the following structures: a hook, a protruding connection, a buckle, a slot, or a snapping hole; correspondingly, the first and second matching parts may include one of the following structures: a matching opening, a matching groove, a matching buckle, a matching protrusion, or a matching stud. Of course, the specific structures of the first snap 141a, the second snap, the first matching part, and the second matching part are not limited, and those skilled in the art may adjust them based on the actual needs as long as the structures serves the purpose of quickly disconnecting the gimbals 140 from the mounting brackets 130.

Further, using the first snap 141a and the first matching part as an example, the connection between the first snap 141a and the first matching part may include a buffer space. The buffer space may include a buffer block, which may be a rubber block, a shock absorbing pad (e.g., a cotton pad), a spring, etc. to reduce the vibration transmitted from the mounting brackets 130 to the gimbals 140. Furthermore, the connection between the second snap and the second matching part may be similar to the connection between the first snap 141a and the first matching part.

It should be understood that the gimbals 140 and the mounting brackets 130 may also be connected using the combination of snapping and screwing to make the connection between the gimbals 140 and the mounting brackets 130 more secure. For example, the gimbal 140 may include an external thread and the upper surface of the gimbal 140 towards the mounting bracket 130 may include a curved protrusion, therefore, when threading the gimbal 140 into a threaded hole on the mounting bracketing 130, the curved protrusion may snap into a curved recess on the mounting bracket 130.

### Sixth Embodiment

Further to the previous Embodiments, the supporting frame 110 may further include a connecting portion connected to the carrier.

More specifically, the supporting frame 110 may be connected to the carrier by welding, and the connecting portion of the supporting frame 110 may be a welding plate. Further, the supporting frame 110 and the carrier may also be detachably connected. In addition, to secure the connection between the supporting frame 110 and the carrier, the supporting frame 110 may include two or more connecting portions. For example, the connecting portion may include one of the following structures: a hook, a protruding connection, a buckle, a slot, or a snapping hole; correspondingly, the carrier may include one of the following structures: a matching opening, a matching groove, a matching buckle, a matching protrusion, or a matching stud to secure the supporting frame 110 to the carrier. The joining structure of the connecting portion and the carrier may have a buffer space, which may include an elastic buffer block to reduce the vibration transmitted from the carrier to the gimbals 140. In particular, the buffer block may be a rubber block, a shock absorbing pad such as a cotton pad, or a spring; or, the connecting portion may be a connecting hole 110a to connect the supporting frame 110 to the carrier through a mounting member 111, where the mounting member 111 may be a bolt, a rivet, or a U-shaped lock, etc. Further, a first shock absorbing member may be disposed between the mounting member 111 and the supporting frame 110 to reduce the vibration transmitted from the carrier to the gimbals 140, where the first shock absorbing member may be a shock absorbing sleeve, a shock absorbing cushion, or a shock absorbing ring.

### Seventh Embodiment

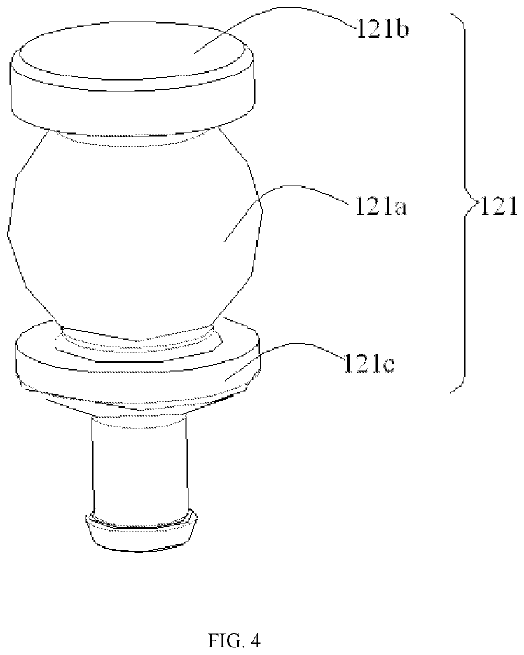

Further to the previous embodiments, FIG. 4 is a schematic structural view of a shock absorbing ball according to a seventh embodiment of the present disclosure. Referring to FIG. 4, and in view of FIGS. 1-3, the shock absorbing structure 120 may include one or more elastic member connected between the supporting frame 110 and the mounting brackets 130, where the elastic member may be a spring, a shock absorbing pad, such as a cotton pad, or a shock absorbing ball 121.

The connection of the elastic member connected between the supporting frame 110 and the mounting brackets 130 will be described using ae spring as an example of the elastic member. In particular, the two ends of the spring may be respectively connected to the supporting frame 110 and the mounting bracket 130 by welding, gluing, etc., so the connection between the supporting frame 110 and the mounting bracket 130 may be more secure; or, one end of the spring may be detachably connected to the supporting frame 110 or the mounting bracket 130, so the mounting bracket 130 may be easily replaced; or, the two ends of the spring may be detachably respectively connected to the supporting frame 110 and the mounting bracket, so the mounting bracket 130 may be easily replaced, and the spring may be easily replaced when the elasticity of the spring has decreased. Further, it should be noted that when the spring is detachably connected to the supporting frame 110 and the mounting bracket 130, a fixing plate may be disposed on the spring to detachably connect the spring to the supporting frame 110 and the mounting bracket 130 through the fixing plate by screwing or snapping.

The connection method of the shock absorbing pad (e.g., cotton pad) and the shock absorbing ball 121 may be similar to the connection method of the spring. It should be noted that each mounting bracket 130 may be connected to the supporting frame 110 by the same or different elastic member; and each mounting bracket 130 may be connected to the supporting frame 110 by a plurality of elastic members, which may be the same or different.

Further, when the elastic member is a shock absorbing ball 121, the shock absorbing ball 121 may include a ball body 121a having oppositely disposed a first end 121b and a second end 121c, where the first end 121b of the shock absorbing ball 121 may be detachably connected to the supporting frame 110, and the second end 121c of the shock absorbing ball 121 may be detachably connected to the mounting bracket 130 by screwing or snapping. The specific connecting structure may be similar to the screwing structure or the snapping structure in the foregoing embodiments, and details are not described herein again. In addition, it should be noted that the ball body 121a of the shock absorbing ball 121 may be attached to the supporting frame 110 and the mounting bracket 130, so the connection between the supporting frame 110 and the mounting bracket 130 may be more compact.

Furthermore, the ball body 121a of the shock absorbing ball 121 may include a shock absorbing medium to further reduce the impact of the vibration of the carrier on the payloads 200 mounted on the gimbals 140. More specifically, the shock absorbing medium may be a shock absorbing oil or a gas. The specific composition of the shock absorbing oil or gas is not limited as long as it may improve the shock absorbing effect of the shock absorbing ball 121.

Further, it should be noted that when the supporting frame 110 is connected to different payloads 200, different types of shock absorbing balls 121 may be used. Furthermore, when shock absorbing ball 121 includes the shock absorbing medium, an inlet may be disposed on the shock absorbing balls 121 to fill the shock absorbing ball 121 with an appropriate amount of shock absorbing medium based on the actual needs and to improve the sealing performance of the shock absorbing ball 121.

### Eighth Embodiment

Further to the previous embodiments, in general, the Gimbal assembly 100 may be disposed at any position of the carrier as long as the Gimbal assembly 100 does not interfere with other components of the carrier, and does not affect the normal operation the payloads 200 carried by the gimbals 140. In this embodiment, as an example, the Gimbal assembly 100 will be described as being disposed under the carrier.

More specifically, the mounting brackets 130 may be disposed under the supporting frame 110, the shock absorbing structures 120 may be disposed between the supporting frame 110 and the mounting brackets 130, that is, the shock absorbing structures may be disposed under the supporting frame 110. At the time, a pull-down shock absorbing structure may be formed. In addition, in this arrangement, the structure of the mounting brackets 130 may be relatively simple.

### Ninth Embodiment

Further to the First to the Seventh Embodiments, in this embodiment, as an example, the Gimbal assembly 100 is still being described as being disposed under the carrier.

More specifically, the mounting brackets 130 may further include an extension bracket that extends above the supporting frame 110 and may be connected to the supporting frame 110 above the supporting frame 110. The shock absorbing structures 120 may be disposed above the supporting frame 110 to form an upward shock absorbing structure. Generally, the compressive strength of a component is greater than its tensile strength. Therefore, in this arrangement, the gravity of the mounting brackets 130, gimbals 140, and the payloads 200 mounted on the mounting brackets 130 may have a compressive force on the shock absorbing structures 120 and the supporting frame 110, which may extend the service life of the shock absorbing structures 120 and the supporting frame 110.

### Tenth Embodiment

Further to the previous embodiments, the supporting frame 110 may be used to carry different gimbals 140, so the supporting frame 110 may carry different payloads 200.

More specifically, the supporting frame 110 may have different mounting brackets 130, where different mounting brackets 130 may be used to mount different gimbals 140 and different gimbals 140 may be used to mount different payloads 200. The gimbals 140 may include the first gimbal 141 and the second gimbal 142, and the mounting bracket 130 may include the first mounting bracket 131 and the second mounting bracket 132. In the present embodiment, the first gimbal 141 and the second gimbal 142 may be different gimbals 140; and the first mounting bracket 131 and the second mounting bracket 132 may be different mounting brackets 130. Further, the first mounting bracket 131 and the second mounting bracket 132 may be simultaneously disposed on the supporting frame 110. Furthermore, the supporting frame 110 may be detachably connected to the mounting brackets 130, at this time, when the first gimbal 141 carried by the supporting frame 110 need to be replaced with the second gimbal 142, the first mounting bracket 131 may be detached from the supporting frame 110, and the second mounting bracket 132 may be connected to the supporting frame 110.

In addition, the supporting frame 110 may have the same mounting brackets 130. The first gimbal 141 and the second gimbal 140 may be used to carrier different payloads 200, however, the first gimbal 141 and the second gimbal 142 may be detachably connected to the same mounting bracket 130, such that when replacing the payload 200, only the gimbal 140 that corresponds to the payload 200 may need to be replaced.

### Eleventh Embodiment

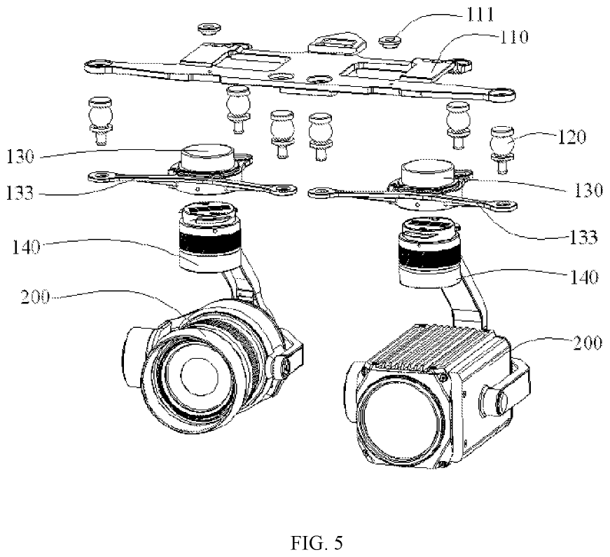

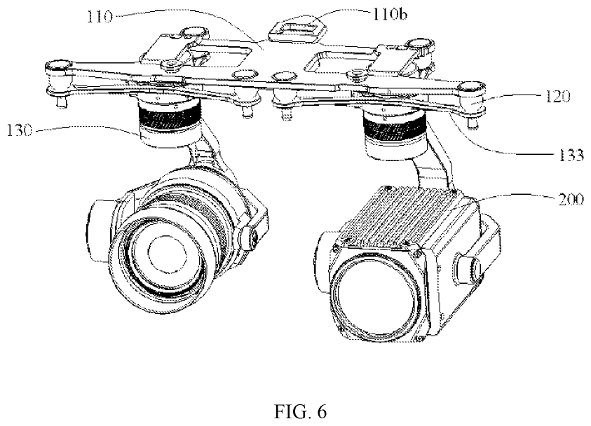

FIG. 5 is a first schematic structural diagram of the gimbal assembly and the payload according to an Eleventh embodiment of the present disclosure and FIG. 6 is a second schematic structural diagram of the gimbal assembly and the payload according to the Eleventh embodiment of the present disclosure. Referring to FIG. 5 and FIG. 6, further to the previous embodiments, the mounting brackets 130 may further include a plurality of quick releases 133 for connecting the shock absorbing structures 120.

In the present embodiment, the quick releases 133 may include two or more arms extending from the side of the mounting brackets 130 such that the mounting brackets 130 may be connected to the shock absorbing structures 120 through the arms, and further connected to the supporting frame 110. Further, the quick releases 133 may be fixedly connected to the mounting bracket 130, for example, by bonding or integrally formed, so the connection may be more secure.

Further, the quick releases 133 may be detachably connected to the mounting brackets 130. Furthermore, the quick releases may include a collar, which may be used to detachably connect to the mounting brackets 130 by screwing or snapping. Two or more arms may extend around the collar, and the mounting brackets 130 may be connected to the shock absorbing structures 120 through the arms. Further, when replacing the mounting brackets 130, only the mounting brackets 130 and the quick releases 133 may need to be disassembled. When the fastening structure of the quick release 133 and the mounting bracket 130 fails due to excessive number of disassembles of the quick releases 133 and the mounting brackets 130, only the quick releases 133 may need to be replaced, which may help to reduce the maintenance cost of the Gimbal assembly 100.

### Twelfth Embodiment

Further to the Eleventh Embodiment, the quick releases 133 may be connected to the supporting frame 110 by three or more connecting members.

More specifically, the connecting member may be a bolt, a rivet, a U-shape lock, etc. The quick releases 133 may include three or more arms, where three arms may be respectively disposed at the three vertices of a triangle, and the arms may be connected to the supporting frame 110 through the connecting members, so the connection between the quick releases 133 and the fixing member 110 may be more secure.

Further, a second shock absorbing member may be disposed between connecting members and the releases 133 or the supporting frame 110 to reduce the vibration transmitted from the supporting frame 110 to the mounting brackets 130, which may further reduce the vibration transmitted from the carrier to the payloads 200 mounted on the gimbals 140. In particular, the second shock absorbing member may be a shock absorbing sleeve, a shock absorbing cushion, a shock absorbing ring, etc.

### Thirteenth Embodiment

Further to the Eleventh Embodiment, the shock absorbing structures 120 may include three or more elastic members, and the quick releases 133 may be connected to the supporting frame 110 through the three or more elastic members. In particular, the structure and function of the elastic members may be the same or similar the elastic member described in the Seventh and Eighth Embodiments, and the details are not described herein again.

Further, three of the three or more elastic members may be respectively disposed at the three vertices of a triangle, so the connection between the quick release 133 and the fixing member 110 may be more secure, and the shock absorbing effect may be better.

### Fourteenth Embodiment

Further to the Eleventh to the Thirteenth Embodiments, the structure of the supporting frame 110 will be described in the present embodiment where the two gimbals 140 are carried by the supporting frame 110, and the quick releases include three arms, however, the structure of the frame is not limited to the present embodiment, and those skilled in the art may modify it based on the actual needs.

The supporting frame 110 may further include a first mounting beam and a second mounting beam, and a connecting beam may be used to connect to the middle of the two mounting beams. Further, two mounting holes may be respectively disposed on two sides of the first mounting beam, one mounting hole may be respectively disposed on two sides of the second mounting beam, so the quick releases 133 may be respectively connected to both sides of the supporting frame 110; or, a first side of the first mounting beam may have two mounting holes, and a second side of the first mounting beam may have one mounting hole, correspondingly, a first side of the second mounting beam that is oppositely disposed from the first mounting beam may have one mounting hole, and a second side of the second mounting beam may have two mounting holes, so the quick releases 133 may be respectively connected to both sides of the supporting frame 110.

In addition, a reinforcing beam may be respectively connected to both sides of the first mounting beam and the second mounting beam, and the reinforcing beam may be disposed near the mounting holes to improve the strength of the supporting frame 110 and extend the service life of the supporting frame 110. In some embodiments, when the mounting brackets 130 are located under the reinforcing beam, the reinforcing beam may be recessed in the direction away from the mounting brackets 130. The space formed by the recess may be used to partially house the mounting brackets 130, so the structure of the carrier carrying the gimbal may be more compact.

### Fifteenth Embodiment

Further to the previous embodiments, the supporting frame 110 may further include a wiring hole 110b for the wires to pass through to the gimbals 140, so the wires connected to the gimbal 140 may be organized. When the carrier of the Gimbal assembly 100 is an airplane frame, the wires may be the wires that connect the gimbals 140 to a power source and/or a flight controller.

The specific location of the wiring hole 110b is not limited in the present embodiment, and those skilled in the art may modify it based on the actual needs. For example, when the supporting frame 110 is disposed on the front side of the carrier, the wiring hole 110b may be disposed on the rear side of the supporting frame 110 to improve the aesthetics of the carrier carrying the Gimbal assembly 100; or, the wiring hole 110b may be disposed towards the power source and the flight controller.

### Sixteenth Embodiment

Further to the previous embodiments, two or more mounting brackets 130 may be arranged based on a predetermined rule such that the two or more gimbals 140 may be arranged by the predetermined rule. The specific rule may be based on the required image information and the number of mounting brackets 130.

For example, when two mounting brackets 130 are mounted on the supporting frame 110, the two mounting brackets 130 may be placed in parallel so the two gimbals 140 carried by the supporting frame 110 may be in parallel as well. In another example, when three or more mounting brackets 130 are mounted on the supporting frame 110, each mounting bracket 130 may be arranged in a linearly arrangement or evenly distributed along the circumference so the gimbals 140 carried by the supporting frame 110 may be linearly arranged or evenly arranged along the circumference.

Further, the orientation of each gimbal 140 carried by the supporting frame 110 may be the same or different, and the orientation of the gimbals 140 may also be the orientation of the payloads 200 carried by the gimbals 140. In particular, the orientation of the gimbals 140 and the placements of the gimbals 140 may be based on the direction corresponding to the desired image information. Furthermore, the payloads 200 mounted on the gimbals 140 may be the same or different. For example, a Z30 zoom gimbal camera (200) may be mounted on one gimbal 140, and a X5S high resolution gimbal camera (200) may be mounted on another gimbal 140.

### Seventeenth Embodiment

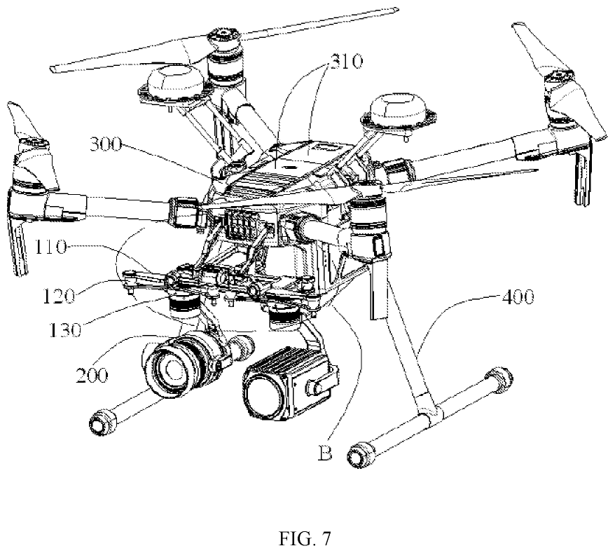

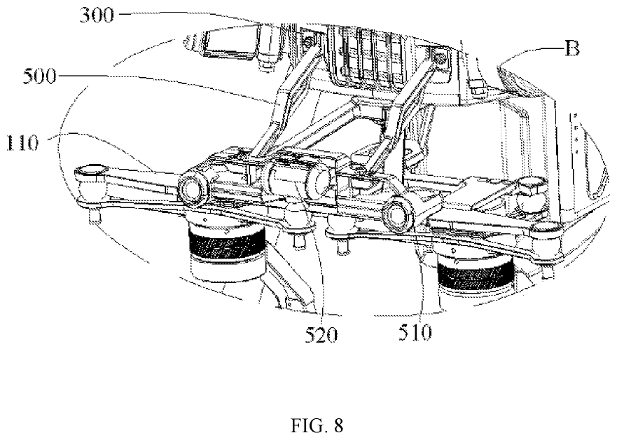

FIG. 7 is a schematic structural view of a frame according to a Seventeenth Embodiment of the present disclosure, and FIG. 8 is a partially enlarged view of FIG. 7. Referring to FIG. 7 and FIG. 8, and in view of FIGS. 1-6, the present embodiment provides a frame having a main body 300; a supporting frame 110 that may be connected to the frame; two or more mounting brackets 130 that may be spaced apart and disposed opposite to the supporting frame 110; a plurality of shock absorbing structures 120 that may be connected between the supporting frame 110 and the mounting brackets 130; and two or more gimbals to carry a plurality of payloads 200, where the two or more gimbals 140 may be fixedly connected to the two or more mounting brackets 130 respectively, and their vibrations may be reduced by the shock absorbing structures 120 such that the supporting frame 110 may carry two or more gimbals 140.

In this embodiment, the structure and function of the Gimbal assembly 100 may be the same as the combination of any one or several of the foregoing Embodiments 1-16, and the details are not described herein again. It should be noted that when the Gimbal assembly 100 in the foregoing Embodiments 1-16 is combined with the frame of the present embodiment, the carrier may be the main body 300 in the present embodiment.

More specifically, the main body 300 may include a main housing to house a plurality of modules such as an inertial navigation module, and the gimbal assembly. Of course, other modules may be added based on the actual use of the UAV, and these modules will not be described herein. In particular, a rotor assembly may be uniformly disposed around the main housing to generate lift to support the UAV in the air. Further, a flight controller may also be disposed in the main housing to control the UAV. When the gimbals 140 and the payloads 200 carried by the main body cause the center of gravity of the UAV to deviate from the center of the UAV, the speed of the motor in the rotor assembly may be adjusted by the flight controller so the UAV may flight more smoothly.

Further, the frame of the present embodiment may need to have certain payload capacity to meet the carrying capacity of the two or more gimbals 140. Furthermore, the frame may also be switched between a single gimbal 140 to a multi-gimbals 140 to increase the flexibility of the UAV. For example, when it is necessary to switch from a multi-gimbals to a single gimbal 140, it may be done by controlling only one of the gimbals 140 through the flight controller, or it may be done by replacing the Gimbal assembly 100. Of course, the frame of the present embodiment may also switch/work with different multi-gimbals 140, and a user may select an appropriate gimbals 140 to use based on the actual need. In particular, the specific switching method may be similar to the foregoing descriptions.

The frame of the present embodiment allows two or more mounting brackets 130 to be mounted on the supporting frame 110 of the Gimbal assembly 100, so the supporting frame 110 may carry two or more gimbals 140, so the payloads 200 mounted on the two or more gimbals 140 may capture two or more image information simultaneously, thereby satisfying the various purposes of the UAV equipped with the frame in the present disclosure.

### Eighteenth Embodiment

Further to the Seventeenth Embodiment, the frame may further include a landing gear 400 for supporting the frame when the UAV lands. The landing gear 400 may be connected to the main body, and it may not block the viewing angles of the payloads 200 mounted on the gimbals 140.

The specific structure of the landing gear 400 is not limited in the present embodiment, and those skilled in the art modify it based on the actual needs, as long as the landing gear 400 can support the frame without affecting the viewing angles of the payloads 200 mounted on the gimbals 140. For example, the landing gear 400 may include a horizontal beam and two vertical beams disposed at the opposite ends of the horizontal beam, where the two vertical beams may be connected to the main body 300; or, the landing gear 400 may include a horizontal beam and a vertical disposed in the middle of the horizontal beam, the vertical beam may be connected to the main body 300 of the frame, that is, the landing gear 400 may be T-shaped.

Further, the mounting bracket may be disposed in front or behind the landing gear 400 such that the gimbals 140 may be disposed in front or behind the landing gear 400, thereby preventing the landing gear 400 from blocking the viewing angles of the payloads 200 mounted on the gimbals 140.

More specifically, the gimbal 140 may be disposed in front or behind the vertical beam of the landing gear 400. When the landing gear includes a plurality of vertical beams, the gimbal 140 may be disposed in front of the frontmost vertical beam or behind the last vertical beam to prevent the beams from blocking the viewing angles of the payloads 200 mounted on the gimbals 140. It may be understood that when the landing gear 400 is T-shaped, the height or the position of the mounting brackets 130 may be adjusted to prevent the horizontal beam from blocking the viewing angles of the payloads 200 carried by the gimbals 140.

### Nineteenth Embodiment

Further to the Seventeenth and the Eighteenth Embodiments, one or more battery compartment 310 may be disposed in the main body 300 to house a battery, which may be used to adjust the center of gravity of the UAV.

More specifically, the battery compartment 310 may be disposed away from the Gimbal assembly 100. Since the payloads 200 carried by the Gimbal assembly 100 may be heavy, the UAV may consume a large amount of electric energy, and the capacity of the battery may need to be increased, which may increase the weight of the battery. Therefore, the battery may be used in adjusting the center of gravity of the UAV, and the position of the battery compartment may help to reduce the size of the frame.

Alternatively, two or more battery compartments 310 may be disposed in the main body 300, where at least one battery compartment 310 may be disposed on one side of the main body 300 facing away from the supporting frame 110. When the main body includes two battery compartments 310, the Gimbal assembly 100 may be disposed in front of the main body 300, the position of the first battery compartment 310 may be the same as the position of the battery compartment 310 in the conventional design, and the second battery compartment 310 may be disposed behind the first battery compartment 310. At this point, when the UAV is switching from a dual-gimbals 140 to a single gimbal 140, the Gimbal assembly 100 having the two gimbals 140 may be replaced with the Gimbal assembly 100 with one gimbal 140, and the battery in the second battery compartment 310 may be removed the adjust the center of gravity of the UAV. In addition, the operating parameters of a first battery in the first battery compartment 310 may be the same as the battery in the conventional design; and the operating parameters of a second battery in the second battery compartment 310 may be adjusted based on the actual needs or it may be the same as the battery in the conventional design.

In some embodiments, the number of battery compartments 310 in the main body 300 may be the same as the number of gimbals 140 in the Gimbal assembly 100, so the center of gravity of the UAV may be adjusted by adjusting the number of batteries in the battery compartments 310 when replacing the Gimbal assembly 100.

### Twentieth Embodiment

Further to the Seventeenth through the Nineteenth Embodiments, a connection bracket 500 may be connected to the front side of the frame, and the connection bracket 500 may be used to mount an obstacle avoidance detection member 510 and a First Person View (FPV) camera 520.

The structure of the connection bracket 500 is not specifically limited in the present embodiment, and those skilled in the art may adjust it based on the actual needs, as long as the he obstacle avoidance detecting member 510 and the FPV camera 520 can be mounted on the connection bracket 500. For example, the connection bracket 500 may be the same as in the conventional design, the arrangement of the obstacle avoidance detecting member 510 and the FPV camera 520 may also be the same as in the conventional design. For example, the FPV camera 520 may be disposed in the middle of the front portion of the UAV, and the obstacle avoidance detection member 510 may be disposed on both sides of the FPV camera 520.

Further, the obstacle avoidance detection member 510 may include one of the following types: an ultrasonic sensor, a radar sensor, and a binocular sensor. Of course, the obstacle avoidance detecting member 510 is not limit herein, and any sensing device capable of detecting obstacles may be used as the obstacle avoidance detecting element 510.

Furthermore, the supporting frame 110 may be fixedly connected to the connection bracket 500. For example, the connection bracket 500 may be located above the supporting frame 110 to effectively prevent the other components in the main body 300 from blocking the viewing angles of the payloads 200 mounted on the supporting frame 110. The specific method of connecting the supporting frame 110 and the connecting bracket 500 may be similar to the method in which the supporting frame 110 and the carrier are connected in the foregoing embodiments, and details are not described herein again.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted, and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An Unmanned Aerial Vehicle (UAV), comprising:
a main body;
a supporting frame that is connected to the main body;
two mounting brackets that are spaced apart;
a plurality of shock absorbing structures that connect the supporting frame and the mounting brackets; and,
two gimbals configured to carry a plurality of payloads, wherein the two gimbals are respectively connected to the two mounting brackets, and the shock absorbing structures absorb shocks on the gimbals.

2. The UAV of claim 1, wherein the gimbals can be quickly disconnected from the mounting brackets.

3. The UAV of claim 2, wherein the two gimbals include a first gimbal and a second gimbal; and the two mounting brackets include a first mounting bracket and a second mounting bracket; the first gimbal includes a first snap and the first mounting bracket includes a receiving part for receiving the first snap to mount the first gimbal on the first mounting bracket; the second gimbal includes a second snap and the second mounting bracket includes a second receiving part for receiving the second snap to mount the second gimbal on the second mounting bracket.

4. The UAV of claim 3, wherein the first snap is the same as the second snap, the first receiving part is the same as the second receiving part, and the first gimbal and the second gimbal are interchangeably mounted.

5. The UAV of claim 3, wherein the first snap is rotatably or slidably connected to the first receiving part; and the second snap is rotatably or slidably connected to the second receiving part.

6. The UAV of claim 1, wherein the supporting frame further includes a connecting portion connected to the main body; and
wherein a first shock absorbing member is disposed between the mounting member and the supporting frame or the main body.

7. The UAV of claim 1, wherein the shock absorbing structures includes one or more elastic members connected between the supporting frame and the mounting brackets.

8. The UAV of claim 7, wherein the elastic member includes a shock absorbing ball, a first end of the shock absorbing ball being detachably connected to the supporting frame, and a second end of the shock absorbing ball being detachably connected to the mounting brackets.

9. The UAV of claim 8, wherein a shock absorbing medium is disposed inside the shock absorbing ball.

10. The UAV of claim 9, wherein the shock absorbing medium includes a shock absorbing oil or a shock absorbing gas.

11. The UAV of claim 1, wherein the mounting brackets are disposed under the supporting frame and the shock absorbing structures are disposed between the mounting brackets and the supporting frame to form a pull-down shock absorbing structure.

12. The UAV of claim 1, wherein mounting bracket includes an extension bracket that is disposed above the supporting frame, and the shock absorbing structures are disposed between the extension bracket and the supporting frame to form an upward shock absorbing structure.

13. The UAV of claim 12, wherein different mounting brackets are mounted on the supporting frame, and different mounting brackets are used for mounting different gimbals.

14. The UAV of claim 1, wherein the main body includes one or more battery compartments to house a battery, and the center of gravity of the supporting frame may be adjusted by adjusting the battery in the battery compartment.

15. The UAV of claim 14, wherein the main body includes two or more battery compartments, and at least one of the two or more battery compartments is disposed on one side of the main body facing away from the supporting frame.

16. The UAV of claim 15, wherein the supporting frame is disposed on a front side of the main body, and at least one of the battery compartments is disposed at the rear portion of the main body to adjust the center of gravity of the supporting frame by adjusting the batteries in the battery compartments.

17. The UAV of claim 1, wherein the front side of the supporting frame is connected to a connecting bracket for mounting an obstacle avoidance detection member.

18. The UAV of claim 17, wherein the obstacle avoidance detection member includes one of: an ultrasonic sensor, a radar sensor, or a binocular sensor.

19. The UAV of claim 17, wherein the connecting bracket is used to mount an FPV camera.

20. The UAV of claim 17, wherein the supporting frame is fixed connected to the connecting bracket, the connecting bracket being located above the supporting frame.
